(19) United States
(12) Patent Application Publication
(10) Pub. No.: US 2008/0235320 A1
(43) Pub. Date: Sep. 25, 2008

(54) Distributed 3D Environment Framework

(76) Inventors: Bruce Joy, Victoria (AU); Henry Tsai, Victoria (AU)

Correspondence Address: BROOKS KUSHMAN P.C., 1000 TOWN CENTER, TWENTY-SECOND FLOOR, SOUTHFIELD, MI, 48075, US

(21) Appl. No.: 12/064,863

(22) PCT Filed: Aug. 25, 2006
(86) PCT No.: PCT/AU2006/001229

§ 371 Date: Feb. 26, 2008

(30) Foreign Application Priority Data
Aug. 26, 2005 (AU) 2005904641

(51) Int. Cl. G06F 15/16; G06F 17/30

(52) U.S. Cl. 709/201; 707/1; 707/E17.107

(57) ABSTRACT

A system for, and client-side and server-side applications for, constructing, connecting and real time management of independent 3D environment portions (2) in a distributed ad hoc network of independent servers to form a seamless massive 3D environment (1). A 3D-aware browser composes multiple interconnected 3D environment portions (2) hosted on separate servers, and has a rendering engine used to render the composed environment (1), allowing users to seamlessly navigate through the ad hoc networks of independent environment portions (2), and facilitating media-rich multi-user interactivity.

### CROSS-REFERENCE TO RELATED APPLICATIONS

The present application claims priority from Australian Provisional Patent Application No 2005904641 filed on 26 Aug. 2005, the content of which is incorporated herein by reference.

### TECHNICAL FIELD

The present invention relates to virtual three-dimensional (3D) spatial environments in a computer network setting, such as over the Internet. In particular the invention relates to a scaleable decentralised infrastructure for independent and self sustained ad-hoc construction, connection, management and control of such a 3D environment.

### BACKGROUND OF THE INVENTION

A 3D environment is a virtual 3D spatial environment that can host multiple users, artificial intelligence (AI) avatars (bots), and objects. Such a 3D environment enables multiple objects, user avatars and artificially intelligent avatars to interact and move about within its space. An independent 3D environment is one that is run on a server or server cluster that is independent in its management from other 3D environments. Independent management often implies independent ownership.

A server is an apparatus comprising means for receiving client requests and controlling which clients may be allowed to participate in the 3D environment, as well as how the client can interact with the entities in the 3D environment. The server may run on the same device as a client, hence a user's machine may act as a client accessing 3D environments and also as a server hosting an independent 3D environment.

Multi-user 3D virtual environments must be constructed prior to deployment and the geometry of a multi-user 3D environment cannot be easily altered or expanded during runtime. Further, there is no existing method to visually and functionally connect together multiple independent, self-sustained 3D environments that are run on independent servers. As a result, there is no support for the users to experience a seamless navigation or an apparently continuous 3D environment which engages with different self-sustained 3D environments.

3D environment architectures generally use a centralized network model that requires either an extremely powerful server or server farm for the hosting of large-scale 3D environments and the serving of the large number of users that are interacting within these massive 3D environments. As a result, the cost of constructing and maintaining these massive 3D environments with large user-base is tremendous and is only affordable to large corporations and companies with enough hardware and software resources.

Another problem with such a centralized approach is that, even if the management of a large-scale environment is distributed among multiple machines, such a 3D environment is nevertheless of a preplanned and static nature. This approach is inevitably not scalable.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect the present invention provides a server side application for hosting an independent environment portion of a 3D virtual environment in conjunction with other servers hosting separate portions of the 3D virtual environment, the server-side application comprising:

code for controlling conditions of the environment portion;

code for communicating with a related server to ensure conformity of the 3D virtual environment connections in common between the two servers; and

code for serving metadata of the environment portion to a user.

In embodiments of the first aspect of the invention, the metadata may define the conditions of the environment portion. Preferably, the metadata is controllable only by the server. Such embodiments prevent client applications or users from corrupting the conditions of the environment portion, for example the rules of game play.

The metadata preferably further defines user attributes such as gaming information (health status, wealth, possessions, etc), for users within or associated with the environment portion of that server. Thus, in such embodiments such attributes are controlled by the server, so as to prevent client applications or users from corrupting such attributes, which in game play situations may prevent cheating.

The user metadata controlled by one server is preferably communicated directly to another server as required, for example as users move or interact between environments.

The metadata preferably describes the virtual dimensions and configuration of the environment portion, for example by describing the virtual dimensions of a 3D mesh of the environment portion. The metadata preferably further comprises connection information relating to one or more connections between the environment portion and other environment portion(s). For example, the environment portion of the server may be geometrically connected with a second environment portion of a second server, or may be logically connected with a second environment portion of a second server for example by a ‘teleport’ connection. A smaller environment portion may be placed within a larger environment portion.

The metadata preferably further describes conditions of the environment portion including one or more of: user location, status, attributes, or bot location, status, attributes, behaviour.

The metadata is preferably served to a user in response to a request from a client application of the user. The metadata may additionally or alternatively be served to the user in response to a communication from a second server that the user requires the metadata, for example when the user is moving towards or within the virtual environment to the environment portion of the server, or when the user has a virtual field of view which takes in the environment portion of the server.

The metadata is preferably in a universal portable standardised format, such as XML.

The server application is preferably operable to transmit and receive broadcast events communicated between servers, so that the broadcast event can be enacted within a plurality of environment portions.

In preferred embodiments, upon alteration to or remodelling of the environment portion, the server is operable to serve new metadata to all client applications having a connection with the server at the time. Such embodiments enable the 3D environment to evolve over time and not be merely a static environment, while only requiring the re-serving of metadata to directly affected users and not necessarily to all users of the entire 3D environment.

The server application preferably further comprises code for monitoring continued operation of a connected server, such as by a ‘heartbeat’ technique. Upon determining that the connected server has become inactive or failed, such embodiments preferably further provide for updating conditions of the environment portion, for example by updating the metadata. For example, virtual connections of the environment portion to an environment portion of the failed server may be disconnected, and the corresponding updated metadata can be re-served to all users active in or associated with the environment portion at that time.

The server application is preferably operable to provide such functionality in respect of a plurality of environment portions.

According to a second aspect the present invention provides a client-side 3D-aware browser application, the client-side application comprising:

code for retrieving metadata for a plurality of environment portions from a plurality of decentralised servers; and

code for rendering a 3D virtual environment composed from the metadata of the environment portions.

In preferred embodiments, the client application further comprises code for pre-emptively retrieving and caching metadata of proximal environment portions from respective servers. Such embodiments are referred to as possessing a caching engine. In such embodiments, the client application preferably comprises code for predicting a next-required environment portion, and code for prioritising download of the metadata for that next-required environment portion. For example, such prediction may be made based upon a direction of travel or a direction of a field of view of the user in the virtual 3D environment. Such embodiments provide improved seamless movement for the user into the next-required or proximal environment portion, as rendering can begin immediately upon or even before the user enters the next environment portion.

In such embodiments, a degree of caching of the caching engine is preferably user defined. For example first degree caching may involve the caching engine obtaining metadata for all immediately connected environment portions, while second degree caching may involve further downloading of metadata for further environment portions connected to the immediately connected environment portions.

In preferred embodiments the client-side application comprises code for allowing user interaction with the environment portions, with other proximal users, and/or with proximal AI entities.

Preferably, the rendering comprises at least one of 3D, 2D, audio, text or augmented reality rendering methods. The rendering preferably comprises substantially live rendering of the 3D position of other user avatars or bots.

Further preferred embodiments of the client-side application comprise code for implementing an interaction engine to minimize latency or lag experienced by a user when interacting or moving between environment portions. The interaction engine preferably maintains a plurality of connections, preferably both active and passive connections, with the necessary servers relevant to the current virtual position of the user. Preferably, an active connection is established when the interaction engine is connected to a server and information relating to the action and reaction of other users in the same environment is being transmitted between them. A passive connection is a network connection made between the client-side browser and an environment server deemed relevant but which does not currently have live data being sent to the client application.

According to a third aspect the present invention provides a system for implementing a 3D virtual environment, the system comprising:

a plurality of distributed servers, each running a server application in accordance with the first aspect of the invention; and

a plurality of users each running a client application in accordance with the second aspect of the present invention.

The system preferably further comprises a global library system, whether centralised or distributed, for asserting globally unique building blocks. For example the global library system may define metadata formats and types. In such embodiments, servers and users can check with the global library system to ensure they have the correct version of any registered building block, object or avatar.

The present invention thus recognises that there is currently no browser engine that is 3D-aware and capable of caching and browsing multiple interconnected independent 3D environments in a seamless manner for the user. Preferred embodiments of the present invention ameliorate the problem that one of the barriers to creating a seamless massive 3D environment across an ad hoc network of servers is the management of sudden disconnections and failures of the logically connected servers in a graceful and timely manner.

The present invention further recognizes that it is important that the architecture, server application client application and overall system of the present invention can be widely adopted. The invention architecture recognizes that virtual 3D environment and system should suit a wide range of devices and display outputs, which means that most widely used computer languages and platforms must be able to support the framework. The framework of the present invention is designed for this purpose. Such widespread support enables even competing technologies and vendors to adopt the framework and interact with the system of the present invention, and so enable users of all types of hardware and platforms to interact in a seamless method

### BRIEF DESCRIPTION OF THE DRAWINGS

An example of the invention will now be described with reference to the accompanying drawings, in which:

FIG. 1 illustrates the rendering of three environment portions into a seamless 3D virtual environment;

FIG. 2 depicts a 3D environment portion comprising a 3D environment bounding box and a 3D mesh, having one geometric connection point;

FIG. 3 illustrates two 3D environment portions with matching geometric interconnections;

FIG. 4 depicts the two 3D environment portions of FIG. 3 when linked, and also depicts two 3D meshes placed next to one another;

FIG. 5 depicts the resulting seamless connection of the two environment portions of FIGS. 3 and 4 as rendered in 3D by the client application;

FIG. 6 depicts a one-to-one unidirectional teleport connection between two environment portions;

FIG. 7 depicts a conceptual massive 3D environment composed of multiple independent environment portions where each bounding box represents an independent 3D portion;

FIG. 8 depicts pre-caching of metadata of the environment portions adjacent to the current 3D environment occupied by the user;

FIG. 9 depicts a network topology in accordance with the present invention; and

FIG. 10 depicts an environment portion having a 3D mesh that can be used to construct an external virtual 3D terrain when used with other similar 3D meshes.

### DESCRIPTION OF THE PREFERRED EMBODIMENTS

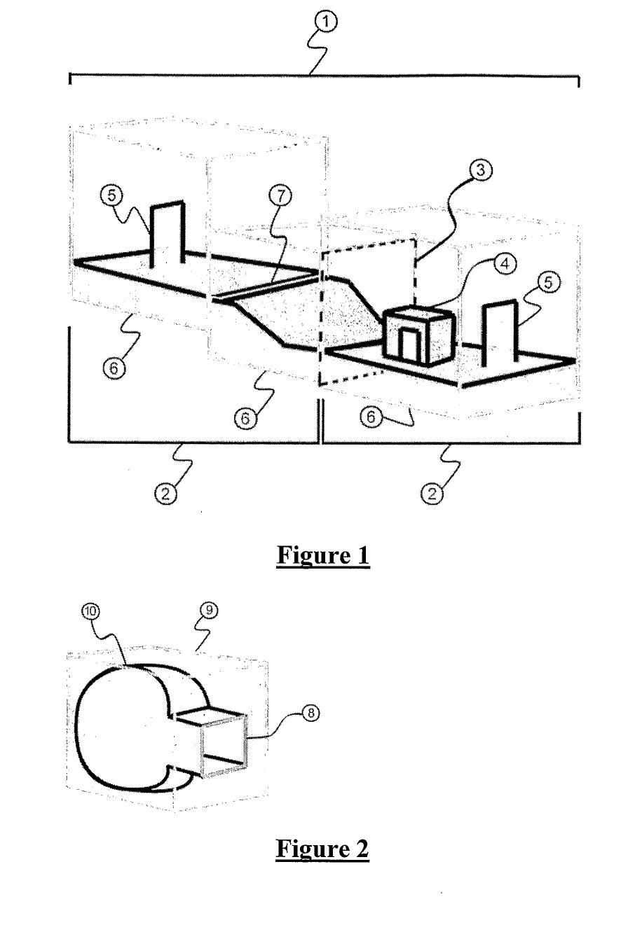

In accordance with an embodiment of this invention, the massive 3D ad hoc environment 1 in FIG. 1 is constructed by linking together independent 3D environment portions 2 through marked connecting points 3, 4 and 5 of the 3D environment portions denoted as visual connections. Each independent 3D environment portion is composed by one or multiple building blocks (3D Meshes) (6 in FIG. 1).

Building blocks (3D Meshes) are used to compose a self-contained independent 3D environment portion in this embodiment. For instance, two building blocks can be placed next to each other shown by 7 in FIG. 1 which allows a designer to construct an apparently continuous virtual space in environment portion 2. Each building block can be reused multiple times and ultimately, the layout and connection of building blocks creates the structure and visual look of each 3D environment portion.

In addition, each independent 3D environment portion of the present invention contains its own interaction rules, and importantly the description of available visual connections to external environment portions. An independent server only hosts, controls and coordinates user, object and environment interactions occurring in its corresponding environment portion. For a 3D environment portion to connect with another environment portion, both environment portions must have compatible visual connection descriptions and agree on the transition of interaction rules.

Thus, the present invention enables multiple 3D environment portions 2 to be composed into a single massive ad hoc environment 1. The invention allows a 3D-aware browser to compose multiple 3D environment portions 2 that are logically connected into one seamless environment 1.

The environment metadata describes the composition of building blocks that form a 3D environment portion and contains information necessary to allow other 3D environment portions to establish visual connections. In the present embodiment, there are two types of visual connections by which a pair of environment portions may entwine, being geometric connections, and teleport connections. These connections are specified in the respective metadata file for each environment portion and can either be manually inserted by environment designers or generated through the use of an automated program or script.

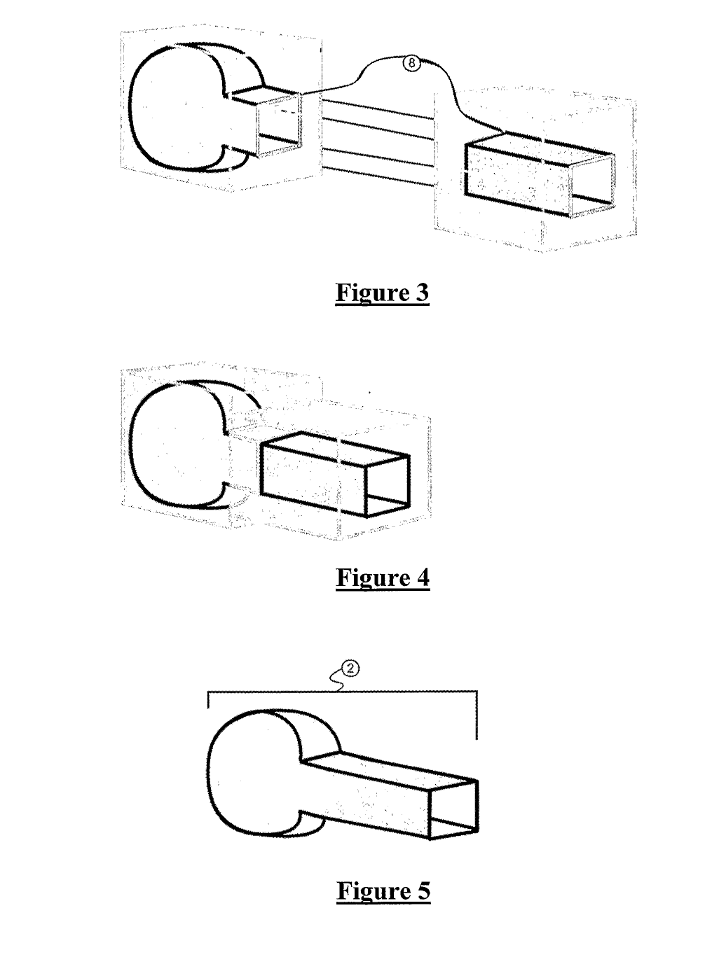

A geometric connection allows meshes of two 3D environment portions to physically join together in the virtual 3D space forming one continuous area. The geometric connections are further divided into entrance connections and embedded connections subcategories. Ali entrance connection requires two 3D environment portions to have one entrance connection point associated with each environment portion, to allow the two environment portions to join with one another side-by-side. In FIG. 2, any of the four pairs of connection points depicted on the entrances 8 of the environment portion can be used to form an entrance connection. The boundary box 9 of the 3D environment portion has to be able to contain the actual 3D mesh 10 referenced by the 3D environment portion. The entrances 8 defined in both of the 3D environment portions in FIG. 3 are identical in dimensions, allowing the two 3D meshes to connect together as shown in FIG. 4. As a result, the user would be presented with one apparently continuous 3D environment 2 as shown in FIG. 5.

On the other hand, an embedded connection allows a smaller 3D environment portion to be embedded within another larger 3D environment portion.

The result of geometric connections is that a user's avatar is able to traverse back and forth between separate 3D meshes that form the rendered environment (composed by the geometric connection of the 3D environment portions) as if the separate 3D meshes were actually one continuous environment. The information included in each environment portion's metadata for instance may include, but is not limited to: boundaries of 3D environment portion (e.g. bounding box of referenced 3D mesh), internal boundary dimensions for embedded connections, spatial location of entrances, visual dimension of each entrance, multiple alternative graphical texture packs to suit different client devices, and references to multiple 3D mesh files.

The metadata describing a 3D environment portion in the present embodiment is specified in an XML based file. The metadata file contains a number of features, including but not limited to definitions of the building blocks being used for the composition of the 3D environment portion itself, and definitions of the connection points of the 3D environment portion.

In this embodiment a building block is a metadata representation for a mesh. This metadata contains a series of properties which are used to enable additional features that normally are not present on a 3D mesh. This also allows metadata representations of the 3D content to be downloaded much faster than the 3D content itself, due to the smaller file size.

Thus, XML elements define a building block, each having a purpose, a type of value that the element will accept (such as string, matrix, float, shader, shader type, etc) and may or may not be compulsory. Sub-elements may be compulsory within the parent element even when the parent element itself is not compulsory. Some example XML elements are briefly described here, however it will be understood by a person in the art that additional or alternative elements may be provided in other embodiments of the invention. The shader element has path, type and texture sub elements which define the type of shader that will be applied to the associated 3D mesh for this building block.

An entrance connection metadata defines a connection formed between independent servers each with one compatible entrances with the other. Metadata elements that define an entrance connection include: position in 3 dimensional space that defines the location of this entrance connection; rotation in 3 dimensional space that defines the rotation (orientation) of this entrance connection; an optional element which is generated only if this entrance connection is part of a linked connection; a URL which points to the server that is linked to this environment portion, and an ID of the linked entrance connection

An embedded connection allows a smaller 3D environment to be embedded within another larger 3D environment. XML elements that define an embedded connection include: the identifying string for this embedded connection, the position in 3 dimensional space that defines the location of this embedded connection; the rotation in 3 dimensional space that defines the rotation (orientation) of this embedded connection. Also, the entry surface dimension being the dimension of the surface that represents this embedded entry, and can be thought as the doorway where users must pass through to enter or leave the smaller environment, which itself includes width of this entry surface dimension; height of this entry surface dimension; an optional element which is generated only if this embedded connection is part of a linked connection; a URL which points to the server that is linked to this server, and an ID of the linked embedded connection.

A teleport connection allows users to teleport from one environment to another though the entrance of an embedded 3D mesh without the need for geometric connections between the environments. Particular types of teleport connections are many-to-one unidirectional, many-to-one bidirectional, one-to-one unidirectional, and one-to-one bidirectional connections. XML teleport elements can include the identifying string for this teleport connection, the 3D mesh that represents the teleport; the path to the file for this teleport mesh, an option allowing a 3D render of the linked destination on a 3D surface; a positional vector for the location of the portal render surface, an optional element which is generated only if this teleport connection is part of a linked connection; a URL which points to the server that is linked to this server and an ID of the linked teleport connection.

Spawn point XML elements can include the identifying string for this teleport connection, a definition of whether this link can be linked by one or more than one teleports; a definition of whether this connection is unidirectional or bidirectional; the 3D mesh that represents the spawn point; the path to the file for this teleport mesh; an optional allowance of a 3D render of the linked destination on a 3D surface; an optional element which is generated only if this teleport connection is part of a linked connection, a URL which points to the server that is linked to this server, and an ID of the linked teleport connection.

It is critical to note that 3D environment portion metadata is decoupled from the actual file format used for the 3D mesh in the present embodiment. In fact, the present embodiment allows 3D environment portion metadata to be generated from any 3D mesh format as long as the rendering engine of the client-side application supports the 3D media file format. Once the 3D environment portion metadata is generated, the corresponding 3D mesh can be greatly altered by a graphics designer, with little limit as long as the entrance points of the environment portion remain the same and in the case of an embedded block, the resultant bounding box of the embedded 3D environment portion does not grow larger.

The 3D environment portion metadata can contain or refer to mesh or media files that are being updated automatically by the external server. This enables an external designer to “broadcast” a design to all environment servers utilizing that design, although the actual implementation may use either “push” or “pull” data transfer paradigm.

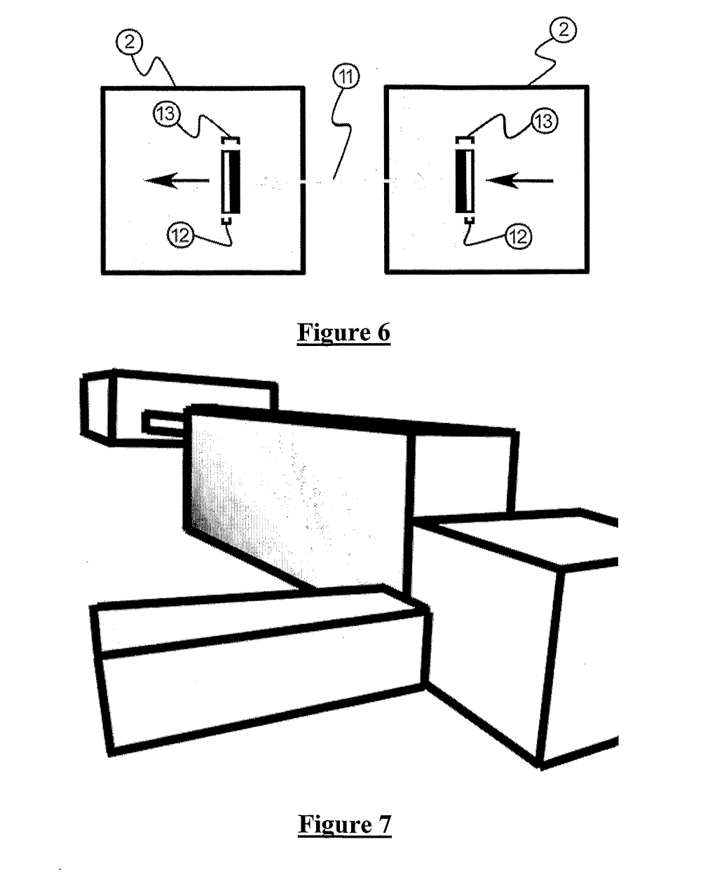

A teleport connection allows users to teleport from one environment to another though the entrance of an embedded 3D mesh without the need for geometric connections between the respective environment portions. In particular, the types of teleport connections are many-to-one unidirectional, many-to-one bidirectional, one-to-one unidirectional, and one-to-one bidirectional connections. A unidirectional connection is represented by a teleport and a spawn point, each located within a separate environment; the teleport allowing a user's avatar to traverse directly through the embedded 3D mesh to another environment at the spawn point. In the case of a bidirectional link, there will be two teleports each with an appropriately located spawn point allowing users to travel backwards and forwards between the environments. By default, the location of a teleport entrance of a bidirectional link serves as the spawn point for the connected environment portion, unless there is a designated spawn point defined for the teleport. Conversely, a many-to-one connection is represented by a spawn point that allows multiple teleports to establish connections to it. A one-to-one connection on the other hand corresponds to a spawn point that allows only one teleport connection. Each teleport needs to be associated with a 3D mesh, which can either have an entry dimension large enough that can be rendered as a “portal” for the user's avatar to pass through, or an interactive 3D mesh that users can activate (via mouse clicking, or key press). The location and the appearance of a teleport 3D mesh may be specified in the environment metadata of the destination environment or the current environment, depending on the agreed configuration between the pair of environments. In FIG. 6, the two independent 3D environments 2 have a bidirectional one-to-one teleport connection 11. The teleport entrances 12 of the teleport meshes 13 allow users in one environment to teleport to the other 3D environment. Since there is no spawn points specified for the teleports, the location of the teleport entrances 12 are the spawn points for the bidirectional teleport connection.

In the environment portion metadata, there is also a line-of-sight zone stored with each external visual connection. The line-of-sight zone data defines an area in the 3D environment such that all the live events and interactions occurring within the defined area are shared between adjacent environment servers. Consequently there is one light-of-sight zone for each and every external visual connection point. This allows the users in the external adjacent environment portions to see real-time interactions that have occurred within the line-of-sight zone of an environment portion.

Other information the environment portion metadata describes relating to the interactivity of the environment portion may include, but is not limited to, the physics engine supported or required, AI engine supported or required, and supported third-party plug-ins, 3D object, game initialization states, rules and triggers.

The 3D environment portion metadata can contain or refer to metadata that is being updated automatically by the external server. This enables an external designer to “broadcast” a design to all environment servers utilizing that design—the actual implementation may use either of the “push” or “pull” data transfer paradigms.

The present embodiment of the invention uses a client-server architecture to enable multiple clients to access individual environment servers. However, the framework utilizes a peer-to-peer network topology between the servers. The decentralized topology of our invention allows for highly effective scalability of a massive ad hoc 3D environment and metadata distribution and for the system to be “self-healing”. Peer-to-peer server connection is an important server-side feature required to facilitate a seamless user experience in a massive ad-hoc 3D environment network.

Specifically, each 3D environment server uses its environment portion metadata to request a visual connection from another environment portion amongst the live server peers. Subsequently, environment servers check each server's environment metadata for mutual connection compatibility. Provided that a compatible connection exists and the two servers agree upon the rules of user exchange, the servers are able to establish the connection. In addition, the requesting server may be required to authenticate and obtain authorization before the visual connection can be established with the other independent environment server. In bidirectional connections, it may require both servers to authenticate and obtain mutual authorization. It is important to realize that by using a peer-to-peer server network topology, the present invention allows sections of the ad hoc massive 3D environment to undergo moderate changes without affecting the overall network. When a 3D environment undergoes some remodeling, it updates its environment portion metadata file which only affects currently linked users and connected (adjacent) environment servers.

Once a visual connection is established, each environment server needs to send live information occurring within its line-of-sight zones to the adjacent environment servers. The typical information sent may include, but is not limited to, user positions within the adjacent line-of-sight zones. Subsequently, each environment server broadcasts the line-of-sight zone information of adjacent 3D environment portions to its connected users if necessary to ensure that, upon rendering, the users in the current environment portion can see and react to the real-time events happening in the adjacent 3D environment portions.

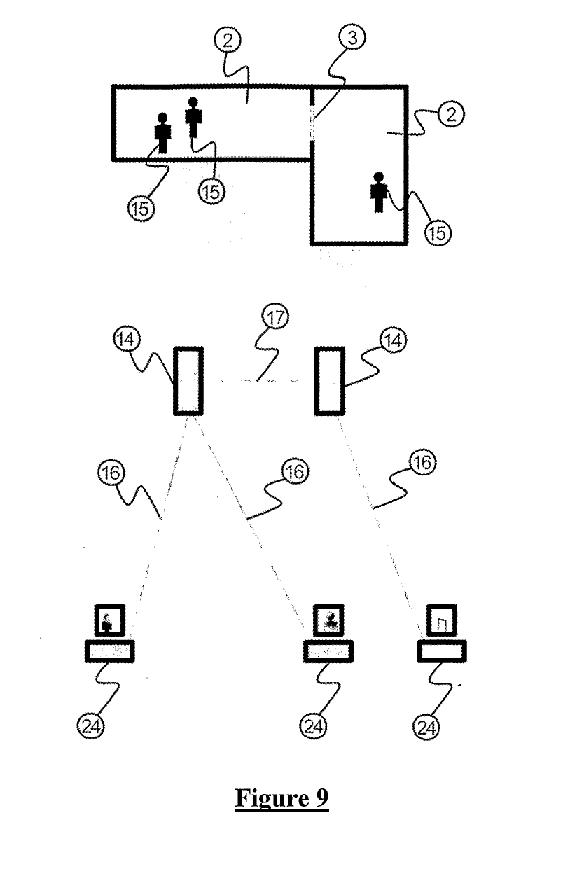

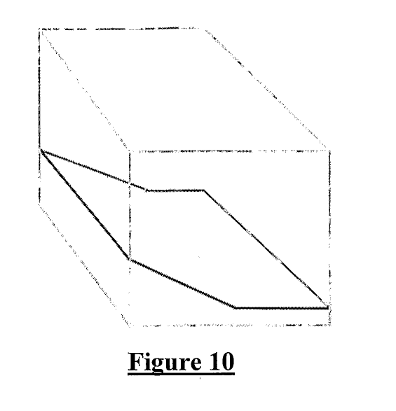

FIG. 9 illustrates a sample scenario. The independent 3D environment portions 2 have a visual connection 3 (environment entrance connection) established. The users 15 in each of the 3D environments connect to the respective environment server via their client device (such as a personal computer or game console) 24 using the client-server paradigm 16. In addition, the environment servers 14 that host the 3D environment portions are required to maintain a P2P connection 17 for exchanging real-time information including the light-of-sight zone data.

Unlike the internet, where dead hyperlinks are common, this embodiment of the invention uses a heartbeat or similar technique between connected servers 14 to ensure each server knows that their external connected environment portions are still available. If a connected server does not respond within a timely manner, the remaining server can alter the environment portion metadata to close that connection and inform its current users that there is new metadata for that environment portion. Also, all users in an environment portion of a server which has failed have the environment portion metadata cached locally, so they are able to still see their environment portion and can be warned by the adjacent servers to leave that environment portion or be cut off. Then linked servers can subsequently offer the failed connection point to a new connection with new servers or just leave the connection point as a closed door or unlinked teleport.

In this embodiment, the preparation for visualization of the ad hoc massive 3D environment is done by a number of controllers in the client-side 3D-aware browser, namely: the caching engine and the interaction engine. The “3D-aware”ness refers to the browser's understanding of 3D spatial properties including the position of the user's avatar, objects and the surrounding environment portion(s) in 3D space.

Because this embodiment is not built upon a specific computer language and platform, the client side browser applications of multiple users may be built on any or all of a wide range of devices, from personal computers, game consoles and handheld devices. Also, because this embodiment encapsulates the information about the scene in a meta-data format, this architecture is able to be independent of any single render engine or display technology. The 3D-aware browser uses the rendering engines available on the local device to render the scene for the user of the device.

To further support this embodiment's cross-platform suitability, multiple environments may be rendered by the 3D-aware browser using methods other than a 3D engine, such as audio, narrative text or a 2D graphical representation.

As a user initially chooses to enter an arbitrary environment portion of a server, the caching engine immediately fetches the corresponding environment portion metadata and all the building blocks (3D meshes), and textures and the like associated with the environment portion. This may be downloaded from the server, other client peers, a centralized or decentralized data distribution system, global library, or 3^{rd} parties and then cached on the client device. At the same time the 3D-aware browser also renders the 3D environment on-the-fly based on data that has already been downloaded. Furthermore, the background downloading of data does not stop even when all the required data is retrieved for the current environment portion. The caching engine continues to make connections to each of the independent servers that hosts environment portions directly linked or connected to the current environment (this includes all environments connected by visual connections), and fetches the metadata required for those further environment portions for caching into the memory in preparation to render these environments when required.

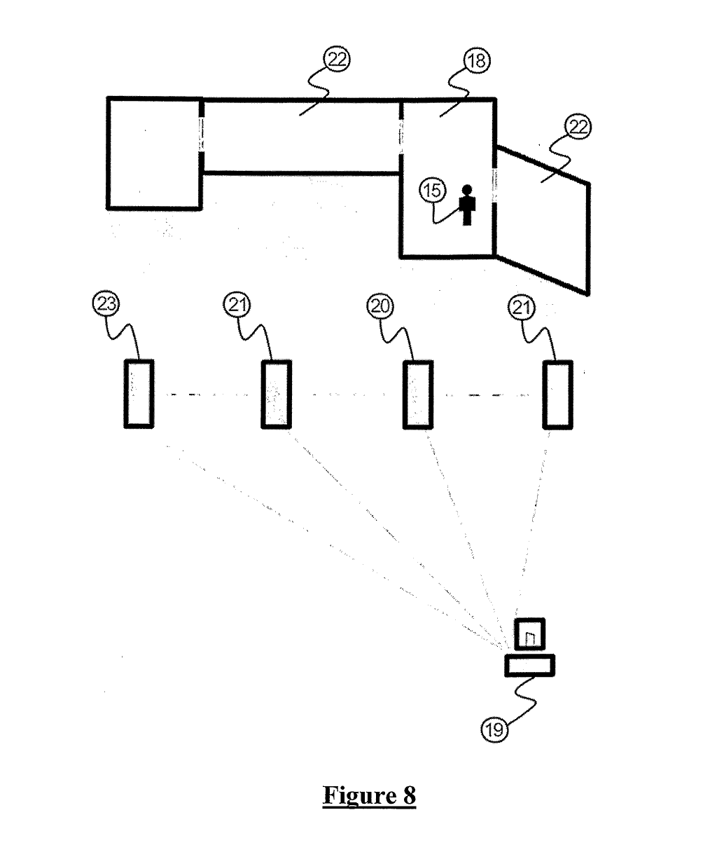

In FIG. 8, the user 15 arrives in the current environment portion 18, the client-side 3D-aware browser 19 is likely to have already fetched data required for the rendering of the environment portion 18 from the current environment server 20. However, the 3D-aware browser continues to fetch information from the first degree adjacent environment servers 21 in preparation for the rendering of the adjacent 3D environment portions as the user's avatar traverses into one of the adjacent environment portions 22. As soon as the 3D-aware browser fetches all the data for the rendering and interactivity of the adjacent environment portions, the 3D-aware browser may be required to pre-cache data from the second degree environment server(s) 23. The degree of pre-caching should be an option specified by the user of the 3D-aware browser.

This pre-caching mechanism is a valuable component in the 3D-aware browser to provide users with seamless navigation through the massive ad hoc 3D environment. Moreover, as a user traverses through the massive 3D environment by connecting to independent servers, the 3D-aware browser unloads data for environment portions that are now far away from the current user position from the computer memory and stores the data locally onto a hard-drive. Maximum disk cache space or storage duration can be set by the user. Moreover, depending on user preference, the 3D-aware browser will carry out different degrees of pre-caching. A higher degree of pre-caching potentially provides a better interactivity and seamless navigation experience for the user.

Thus, the highly scalable 3D environment framework uses a caching engine for caching 3D media files from the independent environment servers that are interconnected, to aid the facilitation of seamless navigation experience. The caching network engine is incorporated in the client-side programs that end-users use to browse the massive 3D environment.

In more detail, the caching engine on the 3D browser should initialize the default path where the metadata needs to be stored upon start-up, and be able to download the metadata file describing the 3D environment composition from the environment server upon request from the client 3D browser. The 3D browser needs the metadata from the server to render the environment portion and get information about the connection points to other proximal environment portions. In this embodiment, this comprises the following sequence:
the caching engine at client side first receives requests containing the 3D environment portion addresses to fetch metadata;
the caching engine at client side establishes a direct connection from the client to the designated server;
the caching engine at client side requests the 3D environment server for the hash value of its metadata;
the caching engine at client side computes the hash value of the metadata residing in the local cache;
the caching engine checks if the hash value obtained from the server side is the same as the hash value of the metadata residing in the local cache;
if the hash value of the metadata differs, the caching engine at the client side requests the server to download the metadata.

If a user decides to enter a particular 3D environment portion, the 3D metadata of this particular environment portion has to be downloaded so that the environment portion is then rendered on the client's 3D browser as part of the massive 3D environment. In this embodiment, this involves the following steps:
the caching engine at the client side parses the metadata fetched from the server to obtain the network addresses to the required 3D media files for rendering;
the caching engine at the client side checks if the listed files are available in the local cache;
if any of the listed files are not present in the local cache then, the caching engine establishes network connections to the source of these 3D media files and downloads them: note that the actual source of the media files can be implemented so that they reside on the environment server, or alternatively these media files may be distributed through a decentralized protocol, such as the BitTorrent protocol; and

the caching engine at the client side updates the status on the availability of each file into a data structure during the downloading of each file.

When a user enters an environment portion, the downloaded metadata file of the 3D environment portion also contains linking addresses of other logically connected servers. In order to maximize the seamless navigation experience of the user, the caching engine in the present embodiment, on an ongoing or continuous basis, caches the metadata files of these adjacent 3D environments in preparation for the visual rendering to occur when the user traverses through to any of the linked or connected environment portions. The amount of caching is determined by an adjustable parameter called the degree of caching. This involves the following steps.

the caching engine provides for client definition of the parameter “Degree of caching”, defined as the hierarchy of logically connected servers to the current server, so that for instance zero degree of caching means that the cache engine does not download any media files apart from the media files required for the interaction and rendering of the 3D environment portion a user is currently in, while one degree of caching means that the caching engine must download all the media files of the 3D environment portions that are directly connected to the virtual environment portion the user is currently in;
the caching engine at the client side downloads metadata files from other linked environment portions depending on the degree of caching parameter; and

the caching engine at the client side reinitiates the downloading process when the user traverses from one environment portion into a new environment portion.

In order to achieve an improved user experience of a seamless, continuous massive 3D environment composed by multiple independent, self-controlled environment portions such that users do not experience lag or latency delays when traversing from one independent environment into another, the client-side environment browser also maintains concurrent network connections to multiple servers, by providing a 3D environment interaction engine. There would be two types of network connections, namely active connections and passive connections.

An active connection is established when the interaction engine is connected to a server and information relating to the action and reaction of other users in the same environment portion is being transmitted between them constantly. A passive connection is a network connection made between the client-side browser and an environment server that is not sending live data.

The interaction engine at the client side maintains concurrent active connections between client-side browser and multiple 3D environment servers, and establishes concurrent passive connections between the client and multiple server. The interaction engine at the client side converts passive connections to active connections; and converts active connections to passive connections, as required. When a user arrives at a 3D environment portion, the interaction engine at the client side establishes an active connection with the corresponding server responsible for that environment portion. In addition, the interaction engine establishes a passive connection with all the environment servers linked to by the current 3D environment portion metadata.

As soon as the user enters a new environment portion, if the interaction engine already has a passive connection with the corresponding server, the passive connection is converted into an active connection. In addition, depending on the specified degree of active connections, the number of concurrent active connections varies. Similar to the “degree of caching” discussed in the preceding, an adjustable parameter “degree of active connections” is provided to specify the layers of active connections counting from the current environment portion in which the user resides. For instance, zero degree of active connections requires that the interactive engine only maintain active connection with the environment server of the 3D environment portion that the user is currently in. One degree of active connections requires that the interactive engine also maintain active connections with the servers pointed to by the metadata of the current environment portion. The value of the degree of active connections is recommended to be set to either 0 or 1.

The active connections established by the interaction engine form a logical tree of connections, so that one degree of active connections requires the interaction engine to establish passive connections to the 3D environments logically linked by the 3D environments servers represented by the “leaf node” connections in the active connections tree. The interaction engine disconnects all other existing connections not included in this definition.

The present embodiment also facilitates continuous self-representation when users explore multiple independent 3D environment portions. This is achieved by the servers that run the connected environment portions handing the latest user state data directly between them when users move between environment portions. The user's client application handles consistent position determination and rendering, but all “valuable game play” data, such as “reputation” or “current assets” are handled directly by the servers. This lowers the risks for the system of users cheating. The servers also initiate the handover of users by providing the other server with the data on all users who are in the line-of-sight zone of the connection with that other server.

The present embodiment further incorporates a method of asserting globally unique building blocks. The benefits of such a system include the ability to obtain the correct block and avoid repeatedly downloading the same building blocks for different environments. The solution provided in this embodiment is a global library system for building blocks and other object data. The global library system is an information repository and can be either centralized or distributed amongst the network. The global library system stores the information (meta-metadata) on metadata including hash, version, date, author and checksum information. Environment servers and users can check with the global library system to ensure they have the correct version of any registered building block, object or avatar. The client or server can compare the hash value of the building block and its version number against the information in the global library system. This ensures incorrect blocks can be detected and helps ensure the users enjoy the same seamless environment.

In the described embodiment, the illustrations show that the bounding box of 3D environment portions are of rectangular shapes. However this is only used to depict one possible implementation. Since a rectangular cube consists of only six faces all perpendicular to each other, environment portion metadata defined based on this shape facilitates easy geometric connections.

A feature of an authentication system that enables servers, users, objects and building blocks to authenticate and assert their identity to others can be used in other embodiments of the invention. The authentication system could take a number of forms: it may be distributed or centralized; it may offer a certificate system; it may be run by a third party. The information independently held and verifiable may include user info such as access passes, possessions, reputation, groups, digital rights management and personal records.

Both the servers and the clients might utilize an Access Control List system that includes groups, white lists and black lists and suits a mixed network topology which would enable environments to automatically restrict access to users who can authenticate their identity and are listed as individuals or belong to listed groups or have a high enough reputation index.

One computer may act as both a server and a client. Users would be able to serve a “home” environment and set it to automatically allow access to friends.

An API or plugin system may be provided that enables environments to require users' 3D-aware browser to be running specific plugins such as a physics system that would enable the same gameplay to be seen by all of the users in an environment.

A number of 3D, 2D and sound engines may be integrated into different versions of the 3D-aware browser to run on a wide range of devices so that users have the opportunity to access the massive 3D environment on a wide range of computing, entertainment, data browsing and communication devices and interfaces.

A standard web browser such as Firefox could use a plug-in or extension that contains the 3D-aware browser, enabling users to interact in the massive 3D environment from within. The rendered visualization can be 2D or as a fully immersive window of real time rendered 3D (using a technology such as Shockwave or Wild Tangent's 3D web engine). The environment metadata contains enough data that a browser plugin can depict the environment as 2D with the floor graphic for a fop down view for instance. Another style of presentation may include a top down and side scrolling window view at the same time.

Thus, this embodiment of the invention provides the means of constructing, connecting and real-time management of independent 3D environments in a distributed ad hoc network of independent servers to form a seamless massive 3D environment. This embodiment includes a 3D-aware browser that is capable of composing multiple interconnected 3D environments being hosted on independent servers so that a rendering engine can be used to render the composed environment. The 3D-aware browser allows users to seamlessly navigate through the ad hoc networks of independent 3D environment portions and facilitates media-rich multi-user interactivity. The outcome of this framework allows the composition of a massive 3D environment that can scale to host the multi-user interaction of a very large number of users across a very large number of independent environment portions.

This embodiment of the invention thus creates a massive 3D environment by interconnecting multiple self-sustained 3D environment portions together. This approach is completely decentralized and can be of an ad hoc nature. Furthermore, this embodiment still allows independent environment servers to control their own environment portion independently. Such large-scale 3D environments can be maintained without the need for a centralized management infrastructure and is highly scalable. In this embodiment, an independent environment portion server only needs to provide enough resources to serve its users. This server does not rely on a central authority for its activities. Multiple 3D environments, hosted by an ad hoc network of multiple independent servers, can be connected during runtime to form a massive 3D environment. The independent 3D environments are able to be continually altered and expanded during their life-time. Users are able to easily navigate through the interconnected independent 3D environment portions as if experiencing one seamless massive 3D environment and users can interact with each other in these environment portions. A number of standardized specifications are used in this embodiment to ensure language and platform independence.

The visual connections in this embodiment allows one environment portion to geometrically connect with another environment portion. This system also provides the means to place one smaller independent 3D environment portion within another bigger 3D environment portion. In addition, this framework also allows two environment portions to make visual teleport connections in which two or more environment portions that are not geometrically connected may nevertheless form a continuous environment. This is achieved by logical connections presented as 3D or 2D meshes in the environment. Further, the system also allows other forms of connections between any pair of environment portions such as broadcasting events occurring in one environment portion being propagated to another. Also provided is the means for users to see and interact with real-time events occurring in adjacent environments.

The architecture and specification of the present embodiment provides the means to decouple the 3D mesh of a 3D environment portion from the metadata required (via visual connection data) to connect the corresponding independent environment portion with other 3D environment portions. Furthermore, the environment metadata also offers the means to change interaction rules, such as game physics of an environment portion.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1.-26. (canceled)

27. A server side application for hosting an environment portion of a 3D virtual environment with other conforming servers hosting separate portions of the 3D virtual environment, the server-side application comprising:
code for controlling conditions of the environment portion;
code for communicating with a conforming other server to ensure conformity of the 3D virtual environment connections in common between the two servers; and
code for serving metadata of the environment portion to a user.

28. The server side application of claim 27 wherein the metadata defines the composition of the environment portion.

29. The server side application of claim 28 wherein the 3D environment portion metadata is decoupled from the actual file format used for rendering the display and can be generated from any mesh or media format by a render engine which supports the content file format.

30. The server side application of claim 28 wherein the metadata can contain or refer to mesh or media files that are being updated automatically by external servers allowing an external designer to “broadcast” a design to all server and client applications.

31. The server side application of claim 27 wherein the metadata is controllable only by the server.

32. The server side application of claim 27 wherein the metadata further comprises user metadata defining user attributes for users within or associated with the environment portion of that server.

33. The server side application of claim 32 wherein the user metadata is communicated directly to another server as users move or interact between environment portions.

34. The server side application of claim 27 wherein the metadata describes the virtual dimensions and configuration of the environment portion.

35. The server side application of claim 27 wherein the metadata further comprises connection information relating to one or more connections between the environment portion and other environment portion(s).

36. The server side application of claim 35 wherein the types of connections supported include many-to-one unidirectional, many-to-one bidirectional, one-to-one unidirectional, and one-to-one bidirectional connections.

37. The server side application of claim 27 wherein the metadata further describes conditions of the environment portion including one or more of: user location, user status, user attributes, bot location, bot status, bot attributes, and bot behavior.

38. The server side application of claim 27 wherein, upon alteration to or remodeling of the environment portion, the server is operable to serve new metadata to all client applications having a connection with the server at the time.

39. A client-side 3D-aware browser application, the client-side application comprising:
code for retrieving metadata for a plurality of environment portions from a plurality of decentralized servers; and
code for rendering a 3D virtual environment composed from the metadata of the environment portions.

40. The client application of claim 39 further comprising caching engine code for preemptively retrieving and caching metadata and related content of proximal environment portions from respective servers.

41. The client application of claim 40 further comprising code for predicting a next-required environment portion, and code for prioritising download of the metadata and related content for that next-required environment portion.

42. The client application of claim 39 wherein a degree of caching of the caching engine is user defined.

43. The client application of claim 39 further comprising code for allowing user interaction with the environment portions, with other proximal users, and/or with proximal AI entities.

44. The client application of claim 39 wherein the rendering comprises at least one of 3D, 2D, audio, text and augmented reality rendering methods.

45. A system for implementing a 3D virtual environment, the system comprising:
a plurality of distributed servers, each running a server application in accordance with claim 27;
a plurality of users each running a client application;
a client-side 3D-aware browser application, the client-side application comprising:
code for retrieving metadata for a plurality of environment portions from a plurality of decentralized servers;
code for rendering a 3D virtual environment composed from the metadata of the environment portions; and
caching engine code for preemptively retrieving and caching metadata of proximal environment portions from respective servers.

46. The system of claim 45 further comprising a global library system asserting globally unique building blocks wherein the global library system is distributed.
